(19) United States
(12) Patent Application Publication
(10) Pub. No.: US 2026/0185452 A1
(43) Pub. Date: Jul. 2, 2026

(54) TURBINE BLADE AND ROTOR

(71) Applicant: Siemens Energy Global GmbH & Co. KG, Munich, Bayern (DE)

(72) Inventor: Ulrich Stanka, Mulheim an der Ruhr (DE)

(73) Assignee: Siemens Energy Global GmbH & Co. KG, Munich, Bayern (DE)

(21) Appl. No.: 18/728,878

(22) PCT Filed: Dec. 21, 2022
(86) PCT No.: PCT/EP2022/087167

§ 371 Date: Jul. 14, 2024

(30) Foreign Application Priority Data
Jan. 20, 2022 (DE) 10 2022 200 592.9

(51) Int. Cl. F01D 5/30

(52) U.S. Cl. CPC F01D 5/3038; F01D 5/3023; F05D 2250/294

(57) ABSTRACT

A turbine blade with a blade root, each of which has two axial projections along a longitudinal axis with radial bearing surfaces for bearing against bearing surfaces of a groove of a turbine disc, wherein the blade root has a depression along a longitudinal axis, which depression extends, in particular, over at least half of the blade root in the direction of the longitudinal axis, and/or has a root projection at one end of the blade root, which root projection can make contact only with a bottom of a groove, wherein the root projection has, in particular, a cross section of at most 30% of the area of the bottom. A rotor having at least one rotor disc with at least one groove and at least one turbine blade of this type is provided.

### CROSS REFERENCE TO RELATED APPLICATIONS

This application is the US National Stage of International Application No. PCT/EP2022/087167 filed 21 Dec. 2022, and claims the benefit thereof, which is incorporated by reference herein in its entirety. The International Application claims the benefit of German Application No. DE 10 2022 200 592.9 filed 20 Jan. 2022.

### FIELD OF INVENTION

The invention relates to a more lightweight turbine blade and to a rotor comprising such turbine blades.

### BACKGROUND OF INVENTION

Turbine blades of turbines, such as of steam turbines or gas turbines, are held in corresponding grooves of turbine disks/rotor disks of a rotor.

The grooves have more or less complementary forms to the blade root.

Examples of these are shown in FIG. 1 of DE 3736836 A1 or in the figure of DE 2549112.

A person skilled in the art continuously seeks to reduce the weight of turbine blades, since the turbine blades are subjected to high mechanical loading owing to the high centrifugal forces.

This can be brought about by using more lightweight materials, although that can also entail higher costs.

### SUMMARY OF INVENTION

An object of the invention is therefore to solve the aforementioned problem.

The object is achieved by a turbine blade as claimed and by a rotor as claimed.

The dependent claims list further advantageous measures which can be combined with one another as desired to afford further advantages.

### BRIEF DESCRIPTION OF THE DRAWINGS

In the figures:

FIG. 1 schematically shows a blade root of a turbine blade in a rotor disk,

FIG. 2 shows the blade root and

FIG. 3 shows the rotor disk.

### DETAILED DESCRIPTION OF INVENTION

The figures and the description with alternatives are only exemplary embodiments of the invention.

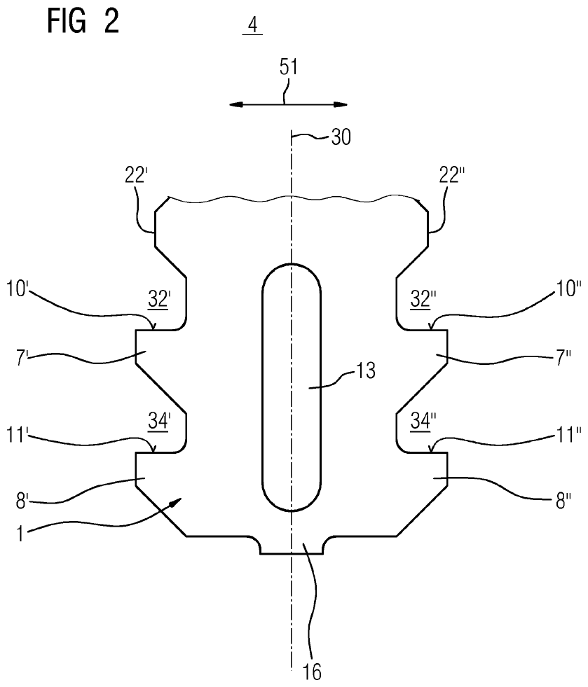

In this case, this is a blade root 1 (FIG. 2) in particular designed in double hammerhead form, as is often used in steam turbines, in particular for steam turbines in the medium-pressure sector.

The invention may, however, also be transferred to other blade roots, such as in particular single hammerheads, and thus also to other grooves with other shapes.

The blade root 1 of a turbine blade (not illustrated in any more detail) has a longitudinal axis 30, which extends radially and in particular constitutes an axis of symmetry at least for the blade root 1.

The longitudinal axis 30 extends radially.

For the sake of a simpler representation, an adjacent optional neck portion, a blade platform and a blade airfoil 4 of the turbine blade are not illustrated in any more detail.

An axial direction 51 extends perpendicularly to the longitudinal axis 30.

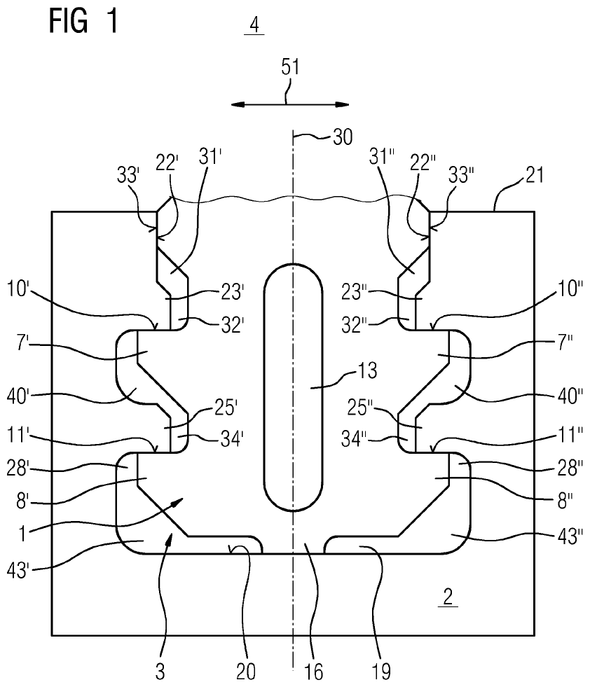

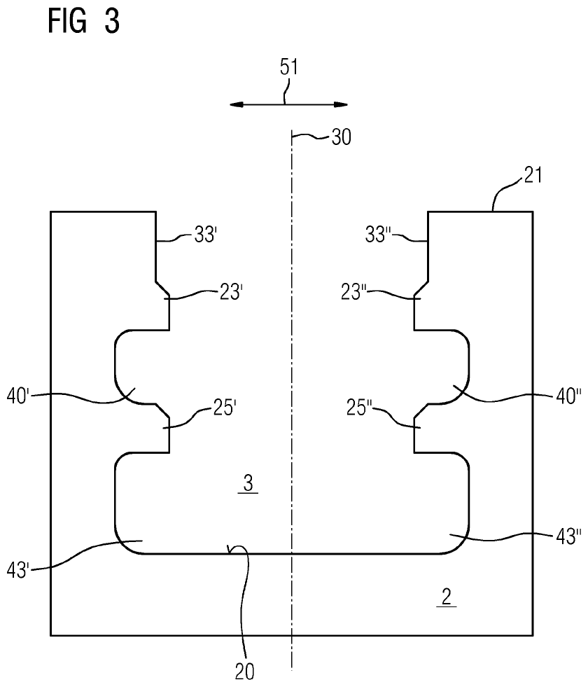

In cross section, the blade root 1 has upper axial projections 7′, 7″ (=7) and lower axial projections 8′, 8″ (=8) on either side, which respectively engage in a rotor disk 2 (FIGS. 1 and 3).

The exemplary embodiment of a double hammerhead form here preferably presupposes that the outer axial side faces of the upper axial projections 7′, 7″ and lower axial projections 8′, 8″ of the blade root 1 are at the same spacing from the longitudinal axis 30 and the longitudinal axis 30 (or a parallel thereto) extends in the planes of these axial projections.

Underneath the blade platform, the blade root 1 has outer axial contact faces 22′, 22″ (=22) on either side, and the longitudinal axis 30 (or a parallel thereto) extends in the plane of these contact faces.

Adjoining these axial contact faces toward the end, as seen in the longitudinal direction, on either side are upper axial recesses 32′, 32″ (=32), which are then followed by the upper axial projections 7′, 7″ of the blade root 1.

The upper axial projections 7′, 7″ have, after the upper axial recesses 32′, 32″, upper radial support faces 10′, 10″ (=10) for making contact with the rotor disk 2 (FIGS. 1 and 3).

A longitudinal axis 30 (or a parallel thereto) extends perpendicularly to the plane of the upper radial support faces 10′, 10″.

Lower axial recesses 34′, 34″, which are then followed by the lower axial projections 8′, 8″ of the blade root 1, follow on from the upper axial projections 7′, 7″.

The lower axial projections 8′, 8″ have, after the lower axial recesses 34′, 34″ (=34), lower radial support faces 11′, 11″ (=11) for making contact with the rotor disk 2 (FIGS. 1 and 3).

The longitudinal axis 30 (or a parallel thereto) extends perpendicularly to the plane of the lower radial support faces 11′, 11″.

The lower radial support faces 11′, 11″ extend preferably parallel to the upper radial support faces 10′, 10″.

The blade root 1 preferably has a root projection 16 at its distal end.

One option for reducing weight and reducing the mechanical loading on the rotor disk 2 is to provide a depression 13 or an aperture 13 in the blade root, in particular in the middle, along the longitudinal axis 30, this depression or aperture extending in particular over the entire depth (perpendicularly to the plane of the drawing) of the blade root 1 and in that case constituting a through-hole.

This depression 13 or this aperture 13 results in a saving on material and thus weight.

The depression 13 is preferably a rectangle in cross section, its corners being semicircular or arcuate or oval.

The shape of the depression 13 is elongate along the longitudinal axis 30 and has no sharp edges or transitions, but instead round transitions.

The rotor disk 2 (FIG. 3) has a bottom 20 in the groove 3.

The groove 3 extends from the surface 21 of the rotor disk 2 firstly along groove contact faces 33′, 33″ (=33) parallel to the longitudinal axis 30, toward the bottom 20.

These groove contact faces are followed by upper axial groove projections 23′, 23″ (=23), protruding into the groove 3, on either side.

These upper axial groove projections are followed in the rotor disk 2 by upper indentations 40′, 40″ (=40), which extend initially preferably perpendicularly to the longitudinal axis 30 and then preferably with a curve, then extend parallel to the longitudinal axis 30 toward the bottom 20 again, and then extend with a curve again.

As seen toward the bottom 20, lower axial groove projections 25′, 25″ (=25) are then present on either side of the groove 3 which preferably have the same spacing from one another as the upper axial groove projections 23′, 23″ do.

These lower axial groove projections are lastly followed in the rotor disk 2 by lower indentations 43′, 43″ (=43), which extend initially preferably perpendicularly to the longitudinal axis 30 and then extend with a curve, then extend parallel to the longitudinal axis 30 toward the bottom 20 again and then transition into the bottom 20 with a rounding.

The longitudinal axis 30 is preferably a perpendicular to the bottom 20.

FIG. 1 illustrates the blade root 3 from FIG. 2 interacting with a rotor disk 2 according to FIG. 3.

The blade root 1 and the groove 3 of the rotor disk 2 have the same longitudinal axis 30.

The axial contact faces 22′, 22″ of the blade root 1 rest against the groove contact faces 33′, 33″ of the rotor disk 2 in the axial direction 51.

These groove contact faces are preferably the only regions of axial contact between the rotor disk 2 and the blade root 1 in the axial direction.

The axial contact faces 22′, 22″ of the blade root 7 preferably do not cover the groove contact faces 33′, 33″ completely, and therefore upper cavities 31′, 31″ (=31) are formed there between the blade root 1 and the rotor disk 2.

The upper radial support faces 10′, 10″ of the upper axial projections 7′, 7″ of the blade root 1 rest, in the upper indentations 40′, 40″ of the groove 3, against the rotor disk 2 in the radial direction of the longitudinal axis 30.

The lower radial support faces 11′, 11″ of the lower axial projections 8′, 8″ of the blade root 1 preferably rest, in the lower indentations 43′, 43″ of the groove 3, against the rotor disk 2 in the radial direction of the longitudinal axis 30.

The spacing between the upper or lower axial projections 7′, 7″; 8′, 8″ is smaller than the maximum spacing between the upper or lower indentations of the rotor disk 2, and therefore central cavities 34′, 34″ (=34) and lower cavities 28′, 28″ (=28) are formed there in the groove 3 between the blade root 1 and the rotor disk 2.

The blade root 1 may rest against the bottom 20 or be fully spaced from the bottom 20 or has, in particular at its end, the root projection 16, which in particular extends symmetrically in relation to the longitudinal axis 30 and thus the blade root 1 on the bottom 20 in the groove 3 of the rotor disk 2 rests against the bottom 20 only partially for stabilization purposes. The root projection 16 has at most 30% of the surface area of the bottom 20.

Therefore, a gap 19 is preferably at least partially present between the end of the blade root 1 and the bottom 20 of the groove 3 around the root projection 16. This also contributes to reducing the weight.

The bottom 20 transversely to the longitudinal axis 30 is preferably wider than the spacing between the contact faces 22′, 22″ of the blade root 1 or between the inner faces at the level of the lower cavity 28.

The blade root 1 is arranged and secured in the groove 3.

The radial contact faces 10, 11 hold the blade root 1 and thus the turbine blade in place in the direction of the longitudinal axis 30; by contrast, there are two axial contact faces 22 of the disk 2 below the level of the surface 21 of the rotor disk 2, against which axial contact faces the blade root 1 rests.

It is also the case here that the entire surface area along the longitudinal axis 30 is intentionally not utilized.

1. A turbine blade, comprising:
a blade root, which has two respective axial projections along a longitudinal axis with radial support faces for making contact with contact faces of a groove of a turbine disk,
wherein the blade root has a depression, along a longitudinal axis, and/or has a root projection at one end of the blade root, which root projection adapted to make contact only with a bottom of a groove.

2. The turbine blade as claimed in claim 1,
wherein the respective axial projections comprise upper axial projections and lower axial projections,
wherein the depression extends along a longitudinal axis at least in length across the upper axial projections and/or across the lower axial projections.

3. A rotor, comprising:
at least one rotor disk having at least one groove, and
at least one turbine blade having a blade root as claimed in claim 1 in the groove.

4. The rotor as claimed in claim 3,
wherein the respective axial projections hold the blade root in a radial direction,
and wherein two groove contact faces of the rotor disk rest against axial contact faces of the blade root in a circumferential direction.

5. The turbine blade as claimed in claim 1,
wherein the depression comprises a through-hole.

6. The turbine blade as claimed in claim 1,
wherein the depression extends over at least half of the blade root in a direction of the longitudinal axis.

7. The turbine blade as claimed in claim 1,
wherein the root projection has a cross section of at most 30% of a surface area of the bottom.

8. The rotor as claimed in claim 4,
wherein only two groove contact faces of the rotor disk rest against the axial contact faces of the blade root in the circumferential direction.
